(19) United States
(12) Patent Application Publication
(10) Pub. No.: US 2023/0036423 A1
(43) Pub. Date: Feb. 2, 2023

(54) Method and Apparatus for Obtaining Identifying Information from Biometric Data

(71) Applicant: Joseph James Yungk, West Palm Beach, FL (US)

(72) Inventor: Joseph James Yungk, West Palm Beach, FL (US)

(21) Appl. No.: 17/390,562

(22) Filed: Jul. 30, 2021

(51) Int. Cl. G06F 16/9535; G06F 16/903; G06F 16/9035; G06Q 50/26; G06F 21/62; G06K 9/00

(52) U.S. Cl. CPC G06F 16/9535; G06F 16/90335; G06F 16/9035; G06Q 50/265; G06F 21/6263; G06K 9/00892

(57) ABSTRACT

A method and apparatus for providing identifying information from a subject in the field using a mobile device is provided. The method of the invention allows for at least three different types of subject supplied information to be used to generate a complete informational profile of the user. The subject may give either name and date of birth, a driver's license, or a fingerprint scan. The relevant data is generated in response to the subject supplied information, the data generated by querying several databases. The identifying information is then returned to the users mobile device for display in a standardized format. Once the application on the users mobile device is closed, the data is deleted and the information is stored on a remote secure server.

### BACKGROUND OF THE INVENTION

### Field of the Invention

The present invention relates to obtaining and processing biometric data. More particularly, the invention is directed to an improved method of obtaining and processing biometric and other data useful for first responders in the field.

### Description of the Prior Art

Identifying individuals using biometric data is a technique that has been used for a number of years. Biometric data is data related to certain unalterable physical characteristics of an individual such as fingerprints or retinal patterns. This data can be used by police officers, first responders, etc., to identify people in the field. However, there are certain issues that arise when equipping, e.g., a police officer, with biometric data processing hardware. For police departments for example, a fingerprint reader was purchased by a department but due to high costs of the hardware, a department of 50 officers may only have 1 or 2. This reduces availability to one or two officers allowed to use the reader and depending on their availability, if they are on shift today or on a call officers may or may not be able to access the device to show the identity of a subject without ID or possible false Id.

In another officer—subject scenario, an officer may request to identify a person by asking for some form of identification. A state issued driver's license or I.D. card, name and date of birth, social security number, or even a passport will be acceptable. If the officer has “reasonable” concerns or suspicions, they are completely within their rights to request name and identification. A traffic stop, a call for service, or suspicious activity are to name just a few of the reasons that would be considered “reasonable” for the requests. Sometimes the identification of a subject is in question. They may claim not to have any form of personal identification on their person and state that they do not know their social security number, or they may provide false information. To get verification of the person's true identity and discovery of warrant activity and criminal history, they must confirm the real identity of the person(s) they are interacting with. This now becomes an issue for Officer safety. If appropriate, the subject's identifying information may be entered into the NCIC (National Crime Information Center) database once obtained.

Fingerprinting has been around for over a century and as of recent, new technology has made access to AFIS (Automated Fingerprint Identification System) more accessible. Using a mobile device or hardware developed to read or capture a latent fingerprint, data can be sent to AFIS for verification and identity.

With the rapid rise in the sophistication of methods and devices for obtaining, transmitting, and receiving digital data, the prior methods can be greatly improved upon. Technology exists for faster and better service response other than simply relying on CAD dispatch and being subjected to call prioritization, which can delay response queries and may limit data and accessibility. Thus, the present invention is directed to methods of efficiently using biometric data to identify individuals in a number of scenarios, particularly those involving police and other first responders.

In another aspect of the invention, the lack of information sharing that exists between departments and organizational hierarchy is still a problem for law enforcement. Accordingly, the invention addresses this issue by seamlessly integrating data from AFIS to NCIC, while also accessing state motor vehicle authority (MVA) information populating the software program, that will then send data regarding warrant activity, criminal history (brief), driver's license status and a photo/picture for further verification of identity all to one platform, which may be a smartphone or other device.

A method and apparatus for providing identifying information from a subject in the field using a mobile device is provided. The method of the invention allows for at least three different types of subject supplied information to be used to generate a complete informational profile of the user. The subject may give either name and date of birth, a driver's license, or a fingerprint scan. The relevant data is generated in response to the subject supplied information, the data generated by querying several databases. The identifying information is then returned to the users mobile device for display in a standardized format. Once the application on the users mobile device is closed, the data is deleted and the information is stored on a remote secure server.

### SUMMARY OF THE INVENTION

It is a major object of the invention to provide an improved method of obtaining biometric data.

It is another object of the invention to provide an improved method of obtaining biometric data using mobile devices.

It is another object of the invention to provide an improved method of obtaining biometric data useful for first responders.

It is another object of the invention to provide an improved method of obtaining identifying information from a subject using one or more different identifying criteria.

It is another object of the invention to integrate identifying information obtained using biometric or other data obtained from a subject using a mobile processing device.

Finally, it is a general goal of the invention to provide improved elements and arrangements thereof in an apparatus for the purposes described which is dependable and fully effective in accomplishing its intended purposes.

These and other objects of the present invention will become readily apparent upon further review of the following specification and drawings.

The present invention meets or exceeds all the above objects and goals. Upon further study of the specification and appended claims, further objects and advantages of this invention will become apparent to those skilled in the art.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 shows a diagrammatic illustration of the overall system environment of the invention.

FIG. 2 shows a diagrammatic illustration of the operation of the software application of the invention.

FIG. 3 shows a diagrammatic illustration of the system detailing operation when given a first data type for subject identification.

FIG. 4 shows a diagrammatic illustration of the system detailing operation when given fingerprint data for subject identification.

FIG. 5 shows a diagrammatic illustration of the system detailing operation when given a second data type for subject identification.

FIG. 6 shows a diagrammatic illustration of the system detailing integration of data obtained from subject inquiry.

FIG. 7 shows a diagrammatic illustration of the system detailing operational protocol using the apparatus of the invention.

### DETAILED DESCRIPTION OF THE PREFERRED EMBODIMENTS

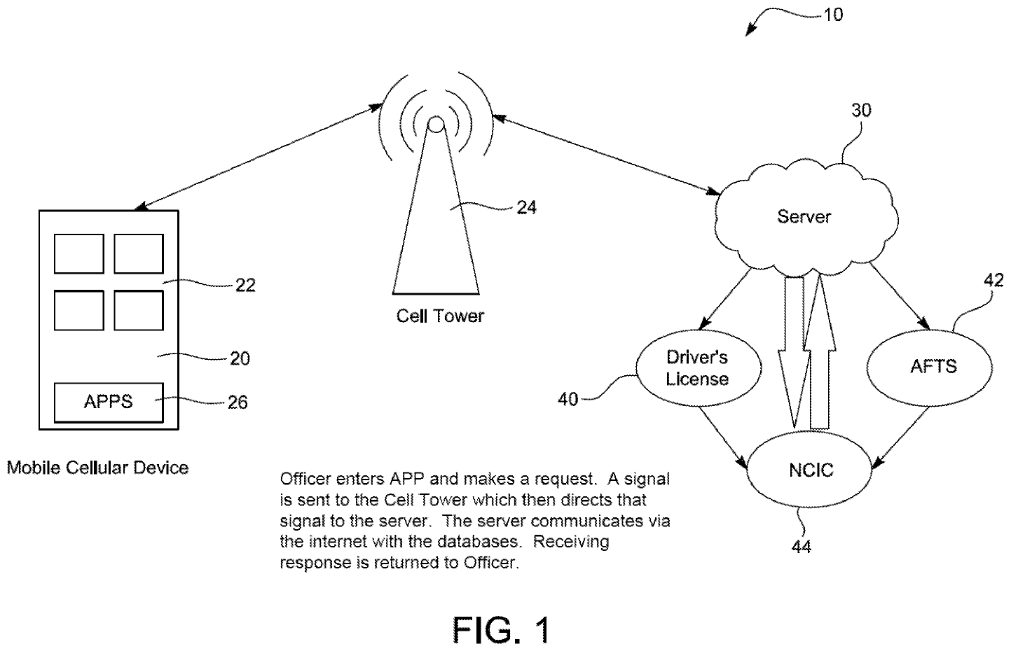

Referring now to FIGS. 1-7, the system of the present invention, generally indicated by the numeral 10, is shown. The system 10 is designed to allow police, first responders, etc., the ability to rapidly obtain information from subjects using mobile electronic devices and has three main operating modes.

In a first operating mode, subjects give identifying information verbally. In a second mode, biometric data is obtained from the subject. In a third mode, the subject's drivers license is used for identification. Regardless of the method used, the user employs a mobile processing device to obtain identifying and other information about the subject, with the data populated and displayed on the mobile device in standardized and easily comprehended format.

Referring now to FIG. 1, the overall system environment is shown. The first component in the system is the user device 20. The user device can be a cell phone, smartphone, tablet, or other electronic data processing device capable of capturing and processing image data and accessing the internet. Such a device 20 would also have alphanumeric character entry and a display 22. The device 20 would access the internet via a cell tower 24 which may use e.g., 5G transmission protocol. An application 26 residing on the device 20 may then communicate with a dedicated server 30, which accesses various databases to complete the user request for identifying information regarding a subject. The user may be a police officer, first responder, etc., and it should be noted that access to the informational databases is limited to authorized personnel.

The three servers of most interest with respect of the present invention are the databases 40 associated with state motor vehicle authorities, the national fingerprint database 42 AFIS (Automated Fingerprint Identification System), and the NCIC (National Crime Information Center) database 44. A key aspect of the invention is that in response to the user request, information regarding a subject is gathered, merged, and presented in a standard format for display on the user device 10.

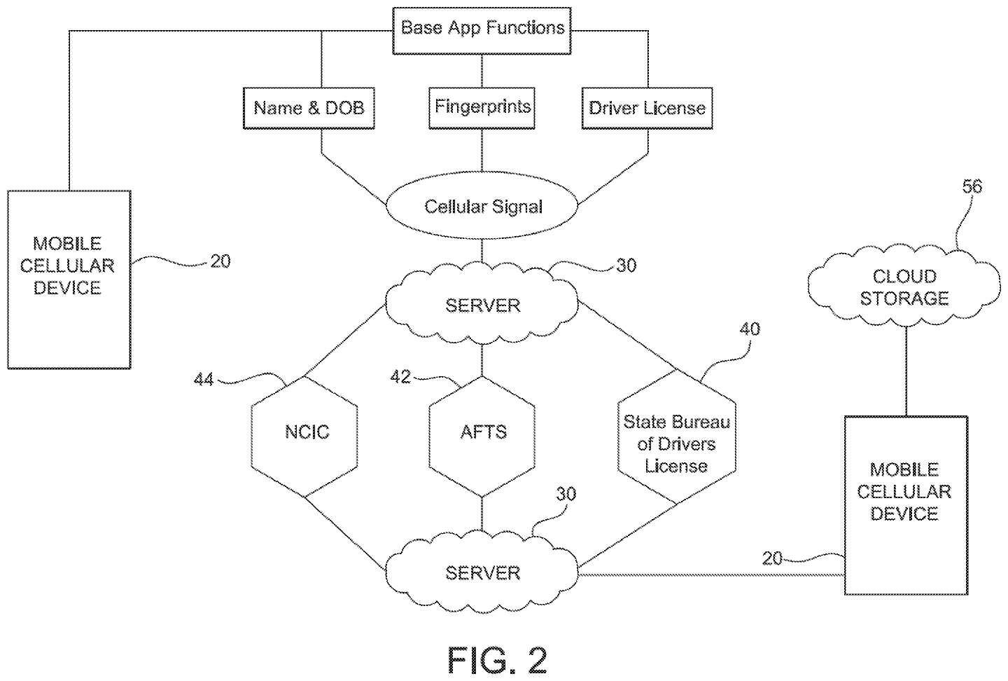

Referring now to FIG. 2, the operation of the inventive system is broadly outlined. The user starts by using the mobile device 20 to make an informational request about a particular subject. The request will be based on one or more types of identifying information provided by the user. The identifying information provided by the user can be name and date of birth 50, biometric (fingerprint) data 52, or a driver's license 54. The application 26 will format the request and transmit to the server 30. The server 30 then queries the NCIC database 44, the AFIS database 42, or the state motor vehicle database 40. The query result is then sent from the server 30 the user device 20, which may then transmit the result to a remote data storage device 56 (the cloud). The application then will allow the users the “optional” transmission of the data to the officer's MDT (Manual Data Terminal/laptop) via a bluetooth connection, which allows the officer and department the option per their required policy or standards for auditing data).

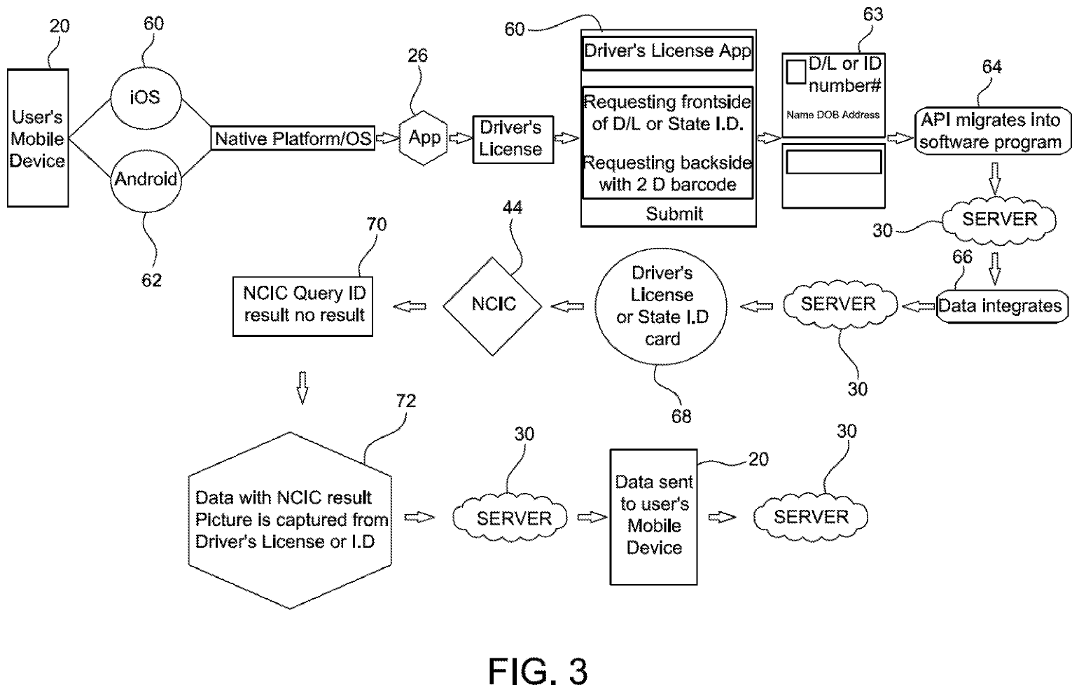

Referring now to FIG. 3, the data flow when the user's request is based on driver's license information provided by the subject is shown. The user device 20 may be a smartphone using either the iOS 60 or Android 62 operating system. The device 20, under control of the user and the inventive application 26 will then scan the front and back of the subject provided license in response to a request, this action being prompted on the display 22 of the user device 20 and shown in block 60. The data 63 from the scan is formatted 64 and migrates to server 30 which then integrates the data into a standardized format 66. The server 30 then presents the standardized data to the NCIC database 44 which will then initiate a query which will produce an output 70. The output 70 is combined with the formatted data 62 in block 72 and transmitted back to the server 30 where it is transmitted to the user device 20.

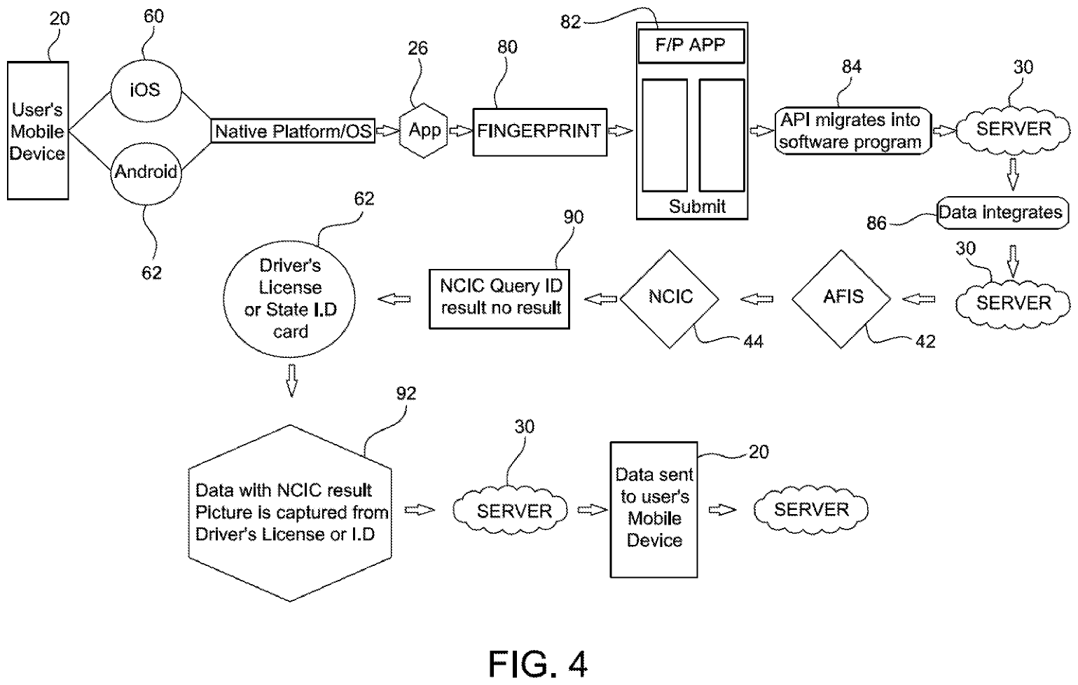

Referring now to FIG. 4, the data flow when the user's request is based on biometric data is shown. The biometric data is fingerprint data, but the method of the invention may be employed with any biometric data provided there is a database containing such biometric data. Again, the user device 20 may be a smart phone using either the iOS 60 or Android 62 operating system. The device 20, under control of the user and the inventive application 26 will then scan the subjects fingerprint 80 in response to a request, this action being prompted on the display 22 of the user device 20 and shown in block 80. The data 82 from the scan is formatted 84 and migrates to server 30 which then integrates the data into a standardized format 86. The server 30 then presents the standardized data to the AFIS 42 and NCIC database 44 which will then initiate a query which will produce an output 90. The output 90 is combined with the formatted data 63 (FIG. 3) and transmitted back to the server 30 where it is transmitted to the user device 20.

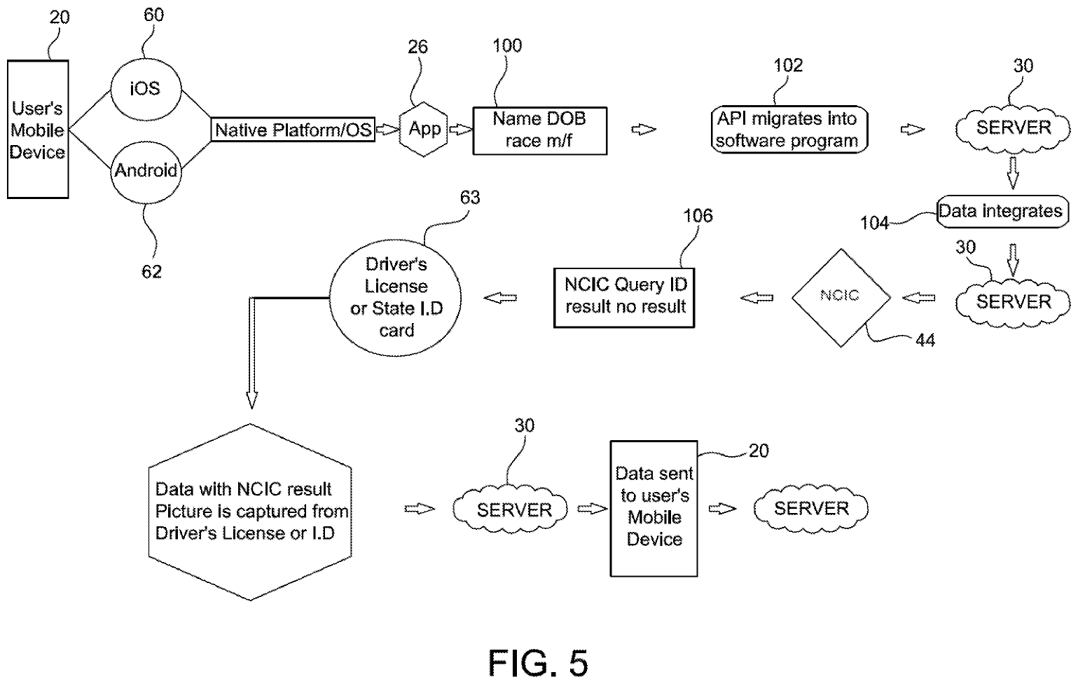

Referring now to FIG. 5, the data flow when the user's request is based on name and date of birth provided by the subject. The device 20, under control of the user and the inventive application 26 will then prompt the user to enter the provided information as shown in block 100. The data 102 from the scan is formatted and migrates to server 30 which then integrates the data into a standardized format 104. The server 30 then presents the standardized data to the NCIC database 44 which will then initiate a query which will produce an output 106. The output 90 is combined with the formatted data 63 (FIG. 3) and transmitted back to the server 30 where it is transmitted to the user device 20.

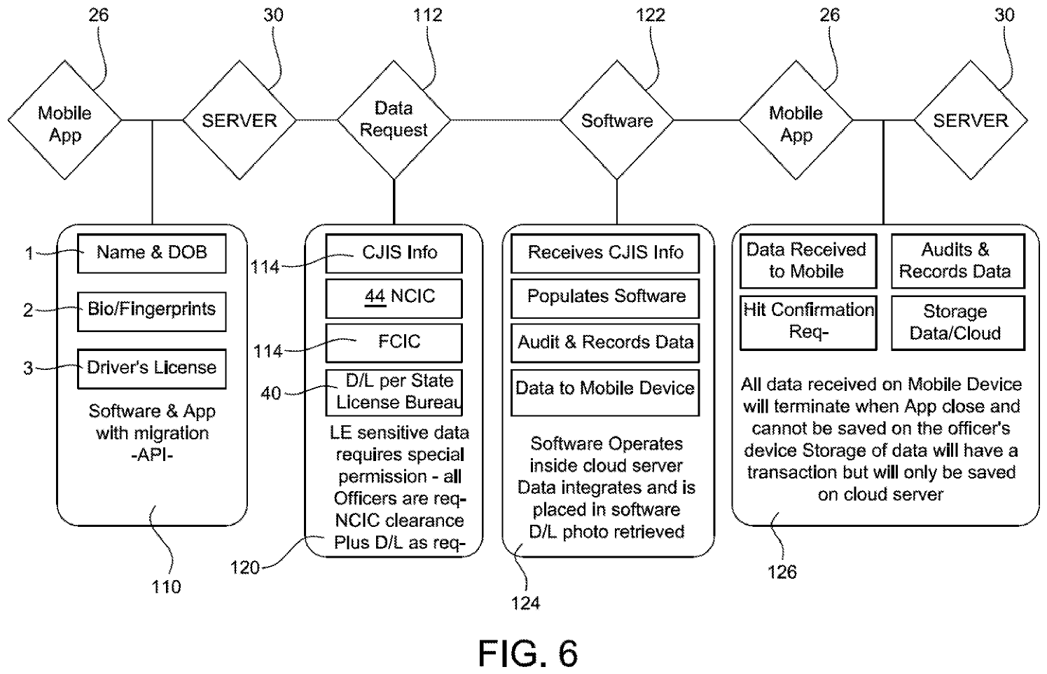

Referring now to FIG. 6, an overview of the data processing scheme of the invention is shown. The mobile application 26 acquires name and DOB 1, biometric data 2, or driver's license information 3 (or combination) as shown in block 110. The user request results in a data request 112, which request produces queries to several databases including CJIS 114, NCIC 44, FCIC 114, and state MVA 40 as seen in block 120. The server 30 software 122 then processes the information as shown in block 124. Specifically, the CJIS data, NCIC data, and FCIC data are compiled and formatted for receipt by the application on the user mobile device 20. This data would include driver's license information including a photo, as well as any other data from federal and local databases that are applicable. The mobile application 26 processes the data generated in block 124 in block 126. The application 26 receives the data and formats it for display on the user device 20. A transaction number or ID is generated for each data request and that number is stored in the application 26. A key aspect of the invention is that the data generated in block 124 is only temporarily saved on the mobile device 20, and then (after the user closes the application 26) sent to the server 30 where it is securely stored. The transaction number is also stored on the server 30 where it can be used for subsequent requests from the mobile device 20. Again, once the data obtained is viewed and the application 26 closed the data is permanently removed from the device 20. The application 26 will save the unique transaction ID to the mobile device 20, which transaction ID will be correlated with the subject in question for subsequent search queries.

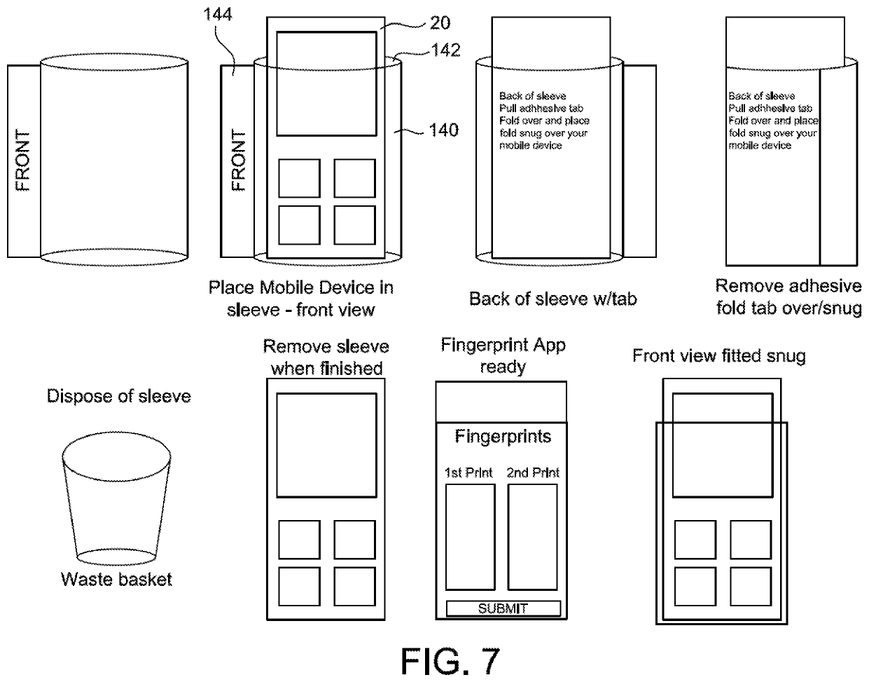

Referring now to FIG. 7, a protective sleeve used with the invention is shown. The sleeve 140 has an opening formed at both ends 142, the openings sized to receive the mobile device 20 prior to a fingerprint scan. A folding tab 144 may be wrapped around to adjust for the size of the mobile device 20, the adjustment allowing for a snug fit about the device. The user may then scan the subject's finger to produce the scan data as discussed above.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

I claim:

1. A method of obtaining identifying information from a subject using a standard mobile device comprising the steps of:
obtaining one of three types of initial identifying data from the subject;
entering the identifying data on said mobile device and initiating a search for said identifying information on one or more databases to produce search results;
integrating said search results and forming a standardized display of said search results for display on said mobile device;
generating and storing a unique transaction ID for said search on said mobile device and,
deleting said search results from said mobile device after viewing.

2. The method of claim 1 wherein one of said three types of identifying data is data from a fingerprint scan.

3. The method of claim 1 wherein one of said three types of identifying data is name and date of birth of the subject.

4. The method of claim 1 wherein one of said three types of identifying data is a driver's license number from the subject.

5. The method of claim 1 wherein one of said databases is an NCIC database.

6. The method of claim 1 wherein one of said databases is a CJIS database.

7. The method of claim 1 wherein one of said databases is an FCIC database.

8. The method of claim 1 wherein one of said databases is a state motor vehicle authority database.

9. The method of claim 1 including the steps of providing a central server for storing said search results and said unique identifier.

10. The method of claim 9 wherein said mobile device can access said search results on the server using said unique identifier.

11. The method of claim 1 including the step of providing a disposable sanitary barrier for said mobile device.
